(19) United States
(12) Patent Application Publication
(10) Pub. No.: US 2013/0083437 A1
(43) Pub. Date: Apr. 4, 2013

(54) ESD DETECTION CIRCUIT AND ESD ELIMINATION DEVICE

(71) Applicant: CHING-HUA HUANG, Miaoli (TW)

(72) Inventor: CHING-HUA HUANG, Miaoli (TW)

(73) Assignee: Fitipower Integrated Technology, Inc., Miaoli County (TW)

(21) Appl. No.: 13/534,034

(22) Filed: Jun. 27, 2012

(30) Foreign Application Priority Data
Oct. 3, 2011 (TW) 100135693

(51) Int. Cl. H02H 9/04

(52) U.S. Cl. 361/56

(57) ABSTRACT

An ESD elimination device includes an ESD elimination circuit connected between a power line and a ground line and an ESD detection circuit. The ESD detection circuit includes a switch unit and a resistor, the switch unit and the resistor are electrically connected between the power line and the ground line. The switch unit is turned on when an ESD event occurs in the power line, a detecting voltage is generated across the resistor when the switch unit is turned on, the detecting voltage is used for triggering the ESD elimination circuit to eliminate the ESD surge current caused by the ESD event.

### BACKGROUND

1. Technical Field

The disclosed embodiments relate to an electrostatic discharge (ESD) detection circuit and an ESD elimination device using the same.

2. Description of Related Art

An ESD elimination device prevents an ESD surge current caused by an ESD event from flowing into an IC, the ESD elimination device includes an ESD detection circuit and an ESD elimination unit, when the ESD detection circuit detects the ESD event, the ESD detection circuit generates a detecting signal. The ESD elimination unit eliminates the ESD surge current caused by the ESD event, in response to the detecting signal.

The ESD detection circuit includes a resistor R and a capacitor C. When the ESD event occurs, the ESD surge current charges the capacitor C via the resistor R. However, the value of the ESD surge current may be very large, thus the capacitance of the capacitor C must be also very large, therefore the physical size of the capacitor C is also large, a lot of space on the print circuit board is taken up by the capacitor C. Additionally, when the capacitor C is still fully charged by a first ESD surge current caused by an ESD event occurred in a certain time period, a subsequent ESD event may not be detected by the ESD detection circuit, therefore the ESD elimination circuit cannot eliminate the second ESD surge current caused by the subsequent ESD event, this may be potentially harmful for the IC.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the eleven views.

FIG. 1 is a circuit diagram of an ESD elimination device in accordance with a first embodiment.

FIG. 2 is a detailed circuit diagram of the ESD elimination device in accordance with a second embodiment.

FIG. 3 is a detailed circuit diagram of the ESD elimination device in accordance with a third embodiment.

FIG. 4 is a detailed circuit diagram of the ESD elimination device in accordance with a fourth embodiment.

FIG. 5 is a detailed circuit diagram of the ESD elimination device in accordance with a fifth embodiment.

FIG. 6 is a circuit diagram showing the ESD elimination device in accordance with a sixth embodiment.

FIG. 7 is a detailed circuit diagram of the ESD elimination device in accordance with a seventh embodiment.

FIG. 8 is a detailed circuit diagram of the ESD elimination device in accordance with an eighth embodiment.

FIG. 9 is a detailed circuit diagram of the ESD elimination device in accordance with a ninth embodiment.

FIG. 10 is a detailed circuit diagram of the ESD elimination device in accordance with a tenth embodiment.

FIG. 11 is a circuit diagram of the ESD elimination device in accordance with an eleventh embodiment.

### DETAILED DESCRIPTION

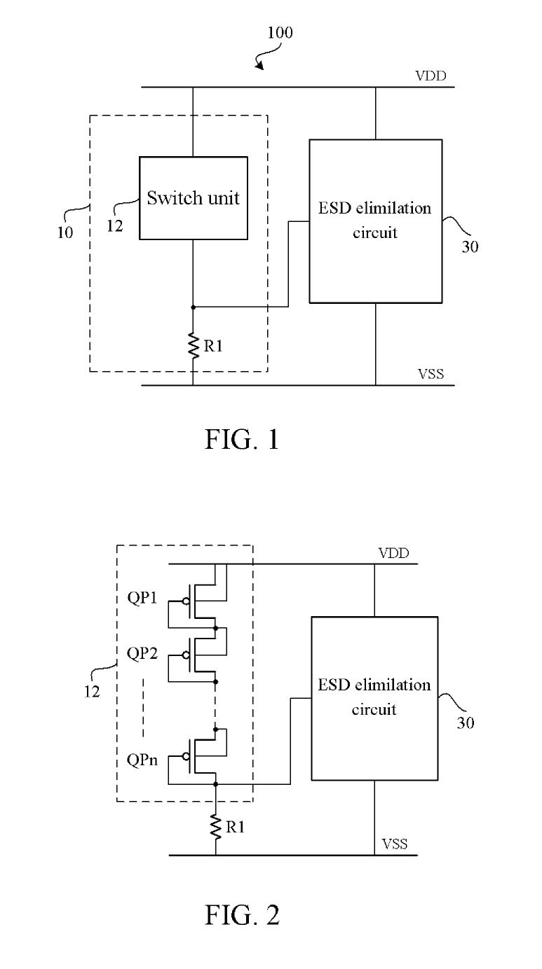

Referring to FIG. 1, an electrostatic discharge (ESD) elimination device 100 includes an ESD detection circuit 10 and an ESD elimination circuit 30. The ESD detection circuit 10 is electrically connected between a power line VDD and a ground line VSS. The ESD elimination circuit 30 is also electrically connected between the power line VDD and the ground line VSS.

The ESD detection circuit 10 in accordance with a first embodiment includes a switch unit 12 and a resistor R1. One end of the resistor R1 is connected to the power line VDD via the switch unit 12, and the other end of the resistor R1 is connected to the ground line VSS. When an ESD event occurs in the power line VDD, the switch unit 12 is turned on, therefore a detecting voltage is generated across the resistor R1, the detecting voltage is used for triggering the ESD elimination circuit 30 to eliminate an ESD surge current caused by the ESD event.

Referring to FIG. 2, the switch unit 12 in accordance with a second embodiment includes a plurality of PMOS transistors QP1, QP2, . . . QPn connected in series between the power line VDD and the resistor R1, each PMOS transistor includes a drain and a gate connected to the drain; the power line VDD is connected to a source of the PMOS transistor QP1, the source of each PMOS transistor is connected to the drain of the PMOS transistor adjacent thereto, the resistor R1 is connected to the drain of the PMOS transistor QPn.

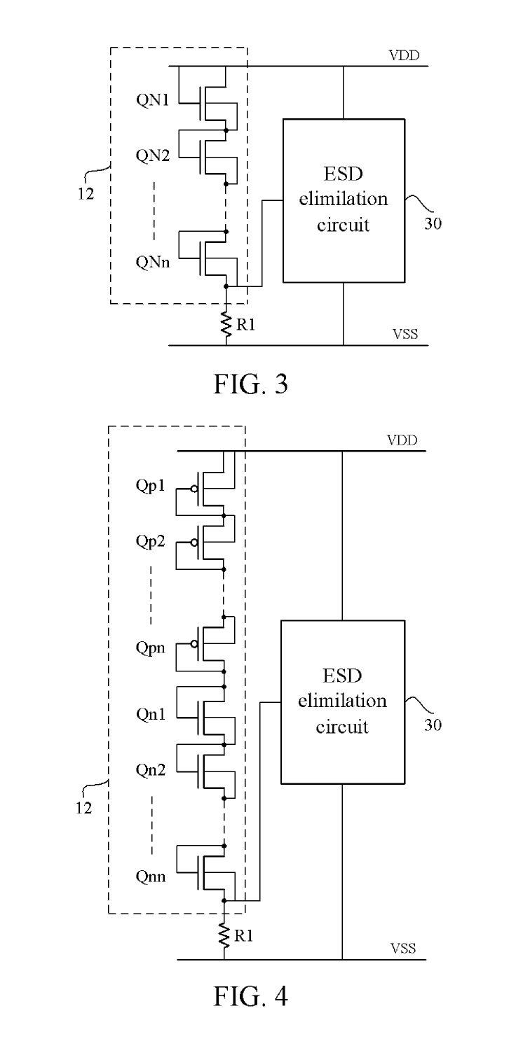

Referring to FIG. 3, the switch unit 12 in accordance with a third embodiment includes a plurality of NMOS transistors QN1, QN2, . . . QNn connected in series between the power line VDD and the resistor R1, each NMOS transistor includes the drain and the gate connected to the drain; the power line VDD is connected to the drain of the NMOS transistor QN1, the source of each NMOS transistor is connected to the drain of the NMOS transistor adjacent thereto, the resistor R1 is connected to the source of the NMOS transistor QNn.

Referring to FIG. 4, the switch unit 12 in accordance with a fourth embodiment includes a plurality of PMOS transistors Qp1, Qp2, . . . Qpn and a plurality of NMOS transistors Qn1, Qn2, . . . Qnn connected in series between the power line VDD and the resistor R1. Each PMOS transistor includes the drain and the gate connected to the drain, the power line VDD is connected to the source of the PMOS transistor Qp1, the source of each PMOS transistor is connected to the drain of the PMOS transistor adjacent thereto. Each NMOS transistor includes the drain and the gate connected to the drain; the drain of the NMOS transistor is connected to the drain of the PMOS transistor adjacent to the NMOS transistor, the source of each NMOS transistor is connected to the drain of the NMOS transistor adjacent thereto. The resistor R1 is connected to the source of the NMOS transistor Qnn. In other embodiments, the switch unit 12 includes a PMOS transistor Qp1 and a plurality of NMOS transistors Qn1, Qn2, . . . Qnn connected in series between the power line VDD and the resistor R1. Alternatively, the switch unit 12 may include a plurality of PMOS transistors Qp1, Qp2, . . . Qpn and a NMOS transistor Qn1 connected in series between the power line VDD and the resistor R1, and the resistor R1 is connected to the source of the NMOS transistor Qn1.

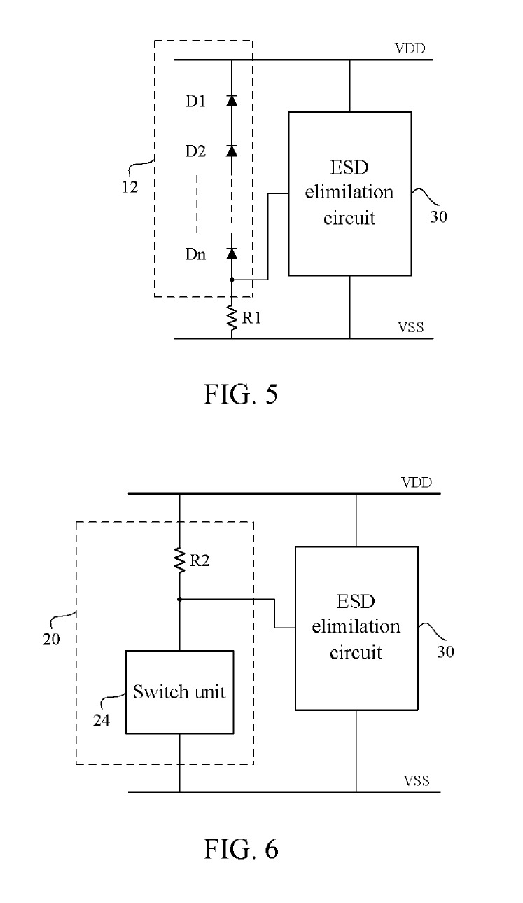

Referring to FIG. 5, the switch unit 12 in accordance with a fifth embodiment includes a plurality of diodes D1, D2, . . . Dn connected in series between the power line VDD and the resistor R1. The power line VDD is connected to a cathode of the diode D1, the cathode of each diode is connected to an anode of the diode adjacent thereto, the anode of each diode is connected to the cathode of the diode adjacent thereto, and the resistor R1 is connected to the anode of the diode Dn.

Referring to FIG. 6, the ESD detection circuit 20 in accordance with a sixth embodiment includes a switch unit 24 and a resistor R2. One end of the resistor R2 is connected to the power line VDD, and the other end of the resistor R2 is connected to the ground line VSS via the switch unit 24. In this embodiment, the ESD elimination device 200 includes the ESD detection circuit 20 and the ESD elimination circuit 30. When the ESD event occurs in the power line VDD, the switch unit 24 is turned on, therefore the detecting voltage is generated across the resistor R2, the detecting voltage triggers the ESD elimination circuit 30 to eliminate an ESD surge current caused by the ESD event. In other embodiments, the ESD elimination device 200 includes the ESD detection circuit 20 and the control circuit 30, the detecting voltage generated across the resistor R1 triggers the control circuit 30 to save data, preventing data loss when an ESD event occurs in the power line VDD.

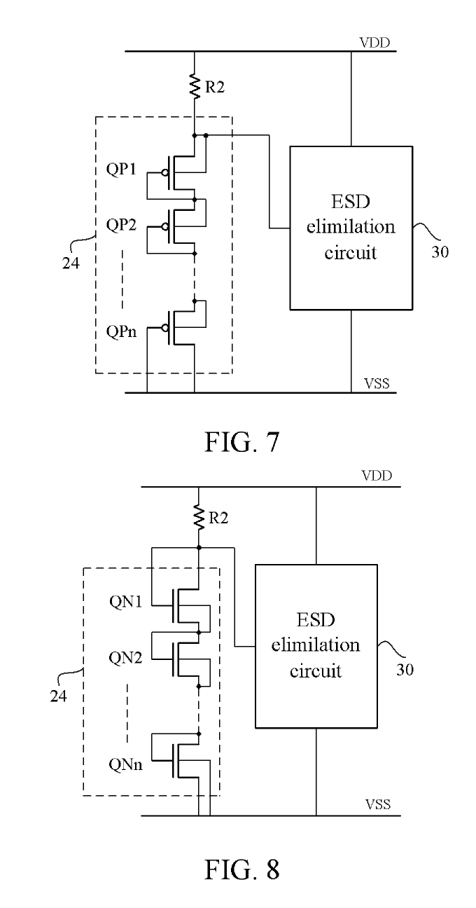

Referring to FIG. 7, the switch unit 24 in accordance with a seventh embodiment includes a plurality of PMOS transistors QP1, QP2, . . . QPn connected in series between the resistor R2 and the ground line VSS, each PMOS transistor includes a drain and a gate connected to the drain; the resistor R2 is connected to a source of the PMOS transistor QP1, the source of each PMOS transistor is connected to the drain of the PMOS transistor adjacent thereto, the ground line VSS is connected to the drain of the PMOS transistor QPn.

Referring to FIG. 8, the switch unit 24 in accordance with an eighth embodiment includes a plurality of NMOS transistors QN1, QN2, . . . QNn connected in series between the resistor R2 and the ground line VSS, each NMOS transistor includes the drain and the gate connected to the drain; the resistor R2 is connected to the drain of the NMOS transistor QN1, the source of each NMOS transistor is connected to the drain of the NMOS transistor adjacent thereto, the ground line VSS is connected to the source of the NMOS transistor QNn.

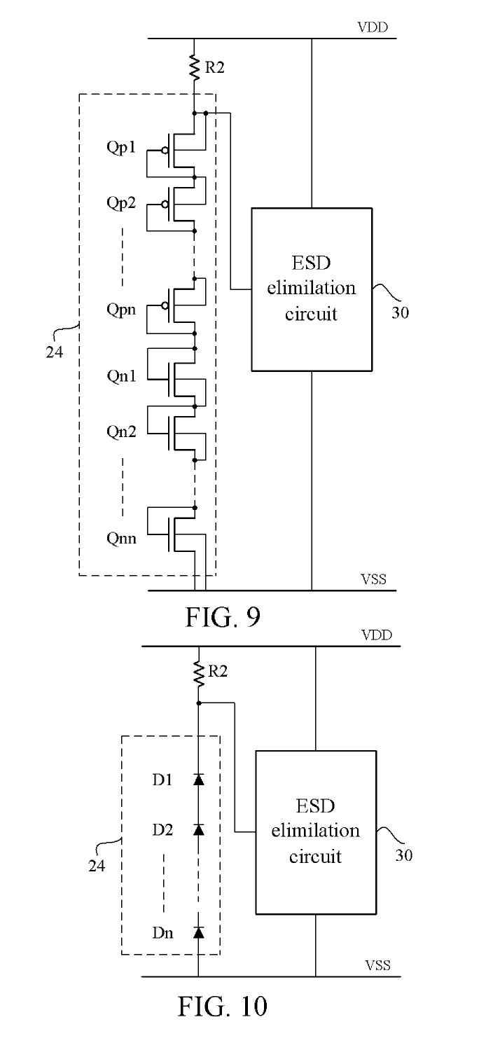

Referring to FIG. 9, the switch unit 12 in accordance with a ninth embodiment includes a plurality of PMOS transistors Qp1, Qp2, . . . Qpn and a plurality of NMOS transistors Qn1, Qn2, . . . Qnn connected in series between the resistor R2 and the ground line VSS. Each PMOS transistor includes the drain and the gate connected to the drain, the resistor R2 is connected to the source of the PMOS transistor Qp1, the source of each PMOS transistor is connected to the drain of the PMOS transistor adjacent thereto. Each NMOS transistor includes the drain and the gate connected to the drain; the drain of the NMOS transistor is connected to the drain of the PMOS transistor adjacent to the NMOS transistor, the source of each NMOS transistor is connected to the drain of the NMOS transistor adjacent thereto. The ground line VSS is connected to the source of the NMOS transistor Qnn. In other embodiments, the switch unit 12 includes a PMOS transistor Qp1 and a plurality of NMOS transistors Qn1, Qn2, . . . Qnn connected in series between the resistor R2 and the ground line VSS. Alternatively, the switch unit 12 may include a plurality of PMOS transistors Qp1, Qp2, . . . Qpn and a NMOS transistor Qn1 connected in series between the resistor R2 and the ground line VSS, and the ground line VSS is connected to the source of the NMOS transistor Qn1.

Referring to FIG. 10, the switch unit 12 in accordance with a tenth embodiment includes a plurality of diodes D1, D2, . . . Dn connected in series between the resistor R2 and the ground line VSS, the resistor R2 is connected to a cathode of the diode D1, the cathode of each diode is connected to an anode of the diode adjacent thereto, the anode of each diode is connected to the cathode of the diode adjacent thereto, the ground line VSS is connected to the anode of the diode Dn.

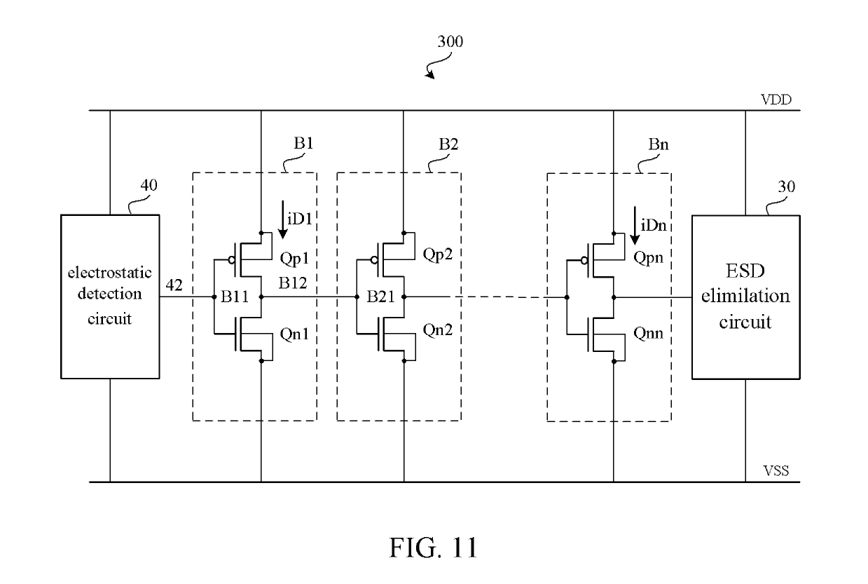

Referring to FIG. 11, the ESD elimination device 300 in accordance with an eleventh embodiment includes the ESD detection circuit 40, a plurality of buffer devices B1, B2, . . . Bn, and the ESD elimination circuit 30. The ESD detection circuit 40 is the same as the ESD detection circuit 10 shown in FIG. 1 and the ESD detection circuit 20 shown in FIG. 6. The ESD detection circuit 40 includes a detection output terminal 42 for outputting the detecting voltage. The plurality of buffer devices B1, B2, . . . Bn are connected in series between the detection output terminal 42 and the ESD elimination circuit 30. Each of the buffer devices B1, B2, . . . Bn is connected between the power line VDD and the ground line VSS.

Each of the buffer devices B1, B2, . . . Bn includes an input terminal, a PMOS transistor, an NMOS transistor and an output terminal, the gate of the PMOS transistor is connected to the gate of the NMOS transistor and the input terminal, the source of the PMOS transistor is connected to the power line VDD, the drain of the PMOS transistor is connected to the drain of the NMOS transistor and the output terminal, the source of the NMOS transistor is connected to the ground line VSS. The input terminal of each buffer device is connected to the output terminal of the buffer device adjacent thereto, and the output terminal of each buffer device is connected to the input terminal of the buffer device adjacent thereto. In detail, the output terminal 42 is connected to the input terminal B11 of the buffer device B1, the ESD elimination circuit 30 is connected to the output terminal Bn2 of the buffer device Bn.

The ESD detection circuits 10 and 20 include the switch unit and the resistor, when an ESD event occurs on the power line VDD, the switch unit is turned on, the detecting voltage is generated across the resistor, and the detecting voltage triggers the ESD elimination circuit 30 to eliminate the ESD surge current caused by the ESD event. Compared to the ESD detection circuit of related art, which includes the capacitor and the resistor, since the capacitor is replaced by the switch unit, the ESD elimination circuit 30 of this embodiment can effectively eliminate the ESD surge current caused by the ESD event.

Alternative embodiments will become apparent to those skilled in the art without departing from the spirit and scope of what is claimed. Accordingly, the present disclosure should not be deemed limited to the above detailed description, but rather limited only by the claims that follow and the equivalents thereof.

What is claimed is:

1. An electrostatic discharge (ESD) detection circuit, comprising:
a switch unit; and
a resistor;
wherein the switch unit and the resistor electrically connected between a power line and a ground line;
wherein the switch unit is turned on when an ESD event occurs in the power line, a detecting voltage is generated across the resistor when the switch unit is turned on, and the detecting voltage is used for triggering an ESD elimination circuit connected between the power line and the ground line to eliminate an ESD surge current caused by the ESD event.

2. The ESD detection circuit of claim 1, wherein one end of the resistor is connected to the power line via the switch unit, and the other end of the resistor is connected to the ground line.

3. The ESD detection circuit of claim 2, wherein the switch unit comprises a plurality of PMOS transistors connected in series between the power line and the resistor, each PMOS transistor comprises a drain and a gate connected to the drain; the power line is connected to a source of the PMOS transistor adjacent to the power line, the source of each PMOS transistor is connected to the drain of the PMOS transistor adjacent thereto, the resistor is connected to the drain of the PMOS transistor adjacent to the resistor.

4. The ESD detection circuit of claim 2, wherein the switch unit comprises a plurality of NMOS transistors connected in series between the power line and the resistor, each NMOS transistor comprises a drain and a gate connected to the drain; the power line is connected to the drain of the NMOS transistor adjacent to the power line, the source of each NMOS transistor is connected to a drain of the NMOS transistor adjacent thereto, the resistor is connected to the source of the NMOS transistor adjacent to the resistor.

5. The ESD detection circuit of claim 2, wherein the switch unit comprises a plurality of PMOS transistors and a plurality of NMOS transistors connected in series between the power line and the resistor, each PMOS transistor comprises a drain and a gate connected to the drain; the power line is connected to a source of the PMOS transistor adjacent to the power line, the source of each PMOS transistor is connected to the drain of the PMOS transistor adjacent thereto; each NMOS transistor comprises a drain and a gate connected to the drain; the drain of the NMOS transistor is connected to the drain of the PMOS transistor adjacent to the NMOS transistor, the source of each NMOS transistor is connected to a drain of the NMOS transistor adjacent thereto; the resistor is connected to the source of the NMOS transistor adjacent to the resistor.

6. The ESD detection circuit of claim 2, wherein the switch unit comprises a plurality of PMOS transistors and a NMOS transistor connected in series between the power line and the resistor, each PMOS transistor comprises a drain and a gate connected to the drain; the power line is connected to a source of the PMOS transistor adjacent to the power line, the source of each PMOS transistor is connected to the drain of the PMOS transistor adjacent thereto; the NMOS transistor comprises a drain and a gate connected to the drain; the drain of the NMOS transistor is connected to the drain of the PMOS transistor adjacent to the NMOS transistor, the resistor is connected to the source of the NMOS transistor.

7. The ESD detection circuit of claim 2, wherein the switch unit comprises a PMOS transistor and a plurality of NMOS transistors connected in series between the power line and the resistor, the PMOS transistor comprises a drain and a gate connected to the drain; the power line is connected to a source of the PMOS transistor, the drain of the PMOS transistor is connected to the drain of the NMOS transistor adjacent to the PMOS transistor; each NMOS transistor comprises a drain and a gate connected to the drain; the source of each NMOS transistor is connected to a drain of the NMOS transistor adjacent thereto; the resistor is connected to the source of the NMOS transistor adjacent to the resistor.

8. The ESD detection circuit of claim 2, wherein the switch unit comprises a plurality of diodes connected in series between the power line and the resistor, the power line is connected to a cathode of the diode adjacent to the power line, the cathode of each diode is connected to an anode of the diode adjacent thereto, the anode of each diode is connected to the cathode of the diode adjacent thereto, the resistor is connected to the anode of the diode adjacent to the resistor.

9. The ESD detection circuit of claim 1, wherein one end of the resistor is connected to the ground line via the switch unit, and the other end of the resistor is connected to the power line.

10. The ESD detection circuit of claim 9, wherein the switch unit comprises a plurality of PMOS transistors connected in series between the ground line and the resistor, each PMOS transistor comprises a drain and a gate connected to the drain; the resistor is connected to a source of the PMOS transistor adjacent to the resistor, the source of each PMOS transistor is connected to the drain of the PMOS transistor adjacent thereto, the ground line is connected to the drain of the PMOS transistor adjacent to the ground line.

11. The ESD detection circuit of claim 9, wherein the switch unit comprises a plurality of NMOS transistors connected in series between the ground line and the resistor, each NMOS transistor comprises a drain and a gate connected to the drain; the resistor is connected to the drain of the NMOS transistor adjacent to the resistor, the source of each NMOS transistor is connected to a drain of the NMOS transistor adjacent thereto, the ground line is connected to the source of the NMOS transistor adjacent to the ground line.

12. The ESD detection circuit of claim 9, wherein the switch unit comprises a plurality of PMOS transistors and a plurality of NMOS transistors connected in series between the ground line and the resistor, each PMOS transistor comprises a drain and a gate connected to the drain; the resistor is connected to a source of the PMOS transistor adjacent to the power line, the source of each PMOS transistor is connected to the drain of the PMOS transistor adjacent thereto; each NMOS transistor comprises a drain and a gate connected to the drain; the drain of the NMOS transistor is connected to the drain of the PMOS transistor adjacent to the NMOS transistor, the source of each NMOS transistor is connected to a drain of the NMOS transistor adjacent thereto; the ground line is connected to the source of the NMOS transistor adjacent to the ground line.

13. The ESD detection circuit of claim 9, wherein the switch unit comprises a plurality of PMOS transistors and a NMOS transistor connected in series between the ground line and the resistor, each PMOS transistor comprises a drain and a gate connected to the drain; the resistor is connected to a source of the PMOS transistor adjacent to the resistor, the source of each PMOS transistor is connected to the drain of the PMOS transistor adjacent thereto; the NMOS transistor comprises a drain and a gate connected to the drain; the drain of the NMOS transistor is connected to the drain of the PMOS transistor adjacent to the NMOS transistor, the ground line is connected to the source of the NMOS transistor.

14. The ESD detection circuit of claim 9, wherein the switch unit comprises a PMOS transistor and a plurality of NMOS transistors connected in series between the ground line and the resistor, the PMOS transistor comprises a drain and a gate connected to the drain; the resistor is connected to a source of the PMOS transistor, the drain of the PMOS transistor is connected to the drain of the NMOS transistor adjacent to the PMOS transistor; each NMOS transistor comprises a drain and a gate connected to the drain; the source of each NMOS transistor is connected to a drain of the NMOS transistor adjacent thereto; the ground line is connected to the source of the NMOS transistor adjacent to the ground line.

15. The ESD detection circuit of claim 9, wherein the switch unit comprises a plurality of diodes connected in series between the ground line and the resistor, the resistor is connected to a cathode of the diode adjacent to the power line, the cathode of each diode is connected to an anode of the diode adjacent thereto, the anode of each diode is connected to the cathode of the diode adjacent thereto, the ground line is connected to the anode of the diode adjacent to the ground line.

16. An ESD elimination device, comprising:
an ESD elimination circuit connected between a power line and a ground line, and
an ESD detection circuit comprising:
a switch unit; and
a resistor; the switch unit and the resistor electrically connected between the power line and the ground line;
wherein the switch unit is turned on when an electrostatic discharge (ESD) event occurs in the power line, a detecting voltage is generated across the resistor when the switch unit is turned on, the detecting voltage is used for triggering the ESD elimination circuit to eliminate an ESD surge current caused by the ESD event.

17. The ESD elimination device of claim 16, wherein one end of the resistor is connected to the power line via the switch unit, and the other end of the resistor is connected to the ground line.

18. The ESD elimination device of claim 16, wherein the switch unit comprises a plurality of PMOS transistors connected in series between the power line and the resistor, each PMOS transistor comprises a drain and a gate connected to the drain; the power line is connected to a source of the PMOS transistor adjacent to the power line, the source of each PMOS transistor is connected to the drain of the PMOS transistor adjacent thereto, the resistor is connected to the drain of the PMOS transistor adjacent to the resistor.

19. The ESD elimination device of claim 16, wherein the switch unit comprises a plurality of NMOS transistors connected in series between the power line and the resistor, each NMOS transistor comprises a drain and a gate connected to the drain; the power line is connected to the drain of the NMOS transistor adjacent to the power line, the source of each NMOS transistor is connected to a drain of the NMOS transistor adjacent thereto, the resistor is connected to the source of the NMOS transistor adjacent to the resistor.

20. The ESD elimination device of claim 16, wherein the switch unit comprises a plurality of diodes connected in series between the power line and the resistor, the power line is connected to a cathode of the diode adjacent to the power line, the cathode of each diode is connected to an anode of the diode adjacent thereto, the anode of each diode is connected to the cathode of the diode adjacent thereto, the resistor is connected to the anode of the diode adjacent to the resistor.
